(19) United States
(12) Patent Application Publication
(10) Pub. No.: US 2021/0333437 A1
(43) Pub. Date: Oct. 28, 2021

(54) ANTI-REFLECTIVE COATINGS AND METHODS OF FORMING

(71) Applicant: CORNING INCORPORATED, CORNING, NY (US)

(72) Inventors: Michael Jerome Cangemi, Canandaigua, NY (US); Bin Wang, Painted Post, NY (US)

(21) Appl. No.: 17/238,283

(22) Filed: Apr. 23, 2021

Related U.S. Application Data
(60) Provisional application No. 63/016,406, filed on Apr. 28, 2020.

(51) Int. Cl. G02B 1/115

(52) U.S. Cl. CPC G02B 1/115

(57) ABSTRACT

An anti-reflective coating including a plurality of first layers, which each comprise a first material with a relatively high refractive index, and a plurality of second layers, which each comprise a second material with a relatively low refractive index. A total thickness of the first layers comprised of the first material is about 120 nm or less. Additionally, the anti-reflective coating is configured to absorb about 0.25% or less of light for a single reflection of the average of the s- and p-polarizations of the light, at every wavelength between about 425 nm to about 495 nm, when the light is propagating under total internal reflection.

This Application claims the benefit of priority from U.S. Provisional Patent Application Ser. No. 63/016,406 filed on Apr. 28, 2020, the content of which is relied upon and incorporated herein by reference in its entirety.

### FIELD

This disclosure relates to anti-reflective coatings, articles including anti-reflective coatings, and methods of forming the same. In particular, this disclosure relates to anti-reflective coatings for optical lenses and glasses to reduce reflections.

### BACKGROUND

Glass cover articles are often used in electronic products to protect critical devices within the products and to provide a platform for user interface and/or display. Such products include augmented and virtual reality devices, mobile devices, night vision systems, and medical imaging devices. Other applications for glass cover articles include eyeglasses, camera lenses, and laser glasses. The performance of these products depends on the optical components used in the design of the glass cover articles. For example, the glass cover articles must have sufficient transmission while minimizing unwanted reflections of light. Additionally, some applications require that the color and/or brightness perceived through the glass cover articles by a user does not change appreciably as the user's viewing angle changes. If the user can detect the change in color and/or brightness with a different viewing angle, the user may experience diminished quality of the display.

Glass cover articles traditionally include a substrate and a coating. The substrate is typically formed of a material having high reflectivity, and the coating is typically a series of one or more layers applied to the substrate. For augmented and virtual reality devices, the substrate is an optical waveguide.

### SUMMARY

Anti-reflective coatings, as disclosed herein, are designed to have low reflectivity and reduce glare, thus being very being beneficial in the applications discussed above. For example, the anti-reflective coatings disclosed herein are especially beneficial in optical lenses and glasses in augmented and virtual reality devices. In these devices, a light path of a virtual image propagates multiple times inside the optical waveguide under total internal reflection (TIR). The light path of the virtual image propagates within the optical waveguide along an axis of the optical waveguide under TIR until it reaches a diffractive optical element, at which point the light path is coupled out of the optical waveguide. While the light path of the virtual image propagates within the optical waveguide under TIR, a light path of a real image transmits through the optical waveguide. The virtual image and the real image light paths, once both coupled out of or transmitted through the optical waveguide, overlap in the user's eye to create the augmented or virtual reality for the user.

The virtual image light path propagating within the optical waveguide bends with an angle greater than the critical angle of the optical waveguide in order to provide the TIR. Stated another way, the virtual image light path, when bouncing within the optical waveguide, strikes the edge of the optical waveguide at an angle greater than the critical angle of the optical waveguide. The angle of the light path must be greater than the critical angle in order for the light path to propagate via TIR. The critical angle of the optical waveguide is given by Snell's Law, as provided in equation (1).

θ_{c}=sin⁻¹(n₂/n₁) (1)

where θ_{c} is the critical angle, n₁ is the index of refraction of the optical medium in which the virtual image is traveling (e.g., the optical waveguide), and n₂ is the index of refraction of the medium adjacent to the optical medium in which the virtual image light path is traveling.

Anti-reflective coatings have been disposed on optical waveguides to increase the efficiency of the light paths of the real images transmitted through the optical waveguide. Increasing the transmittance reduces unwanted reflections that occur when light travels backwards in the system. However, traditional anti-reflective coatings, although beneficial for transmittance, inadvertently cause some of the light propagating within the optical waveguide to be absorbed by the coating. More specifically, some of the light of the virtual image is absorbed by the coating each time the light path bounces off the edges of the optical waveguide. Therefore, more light is at the beginning of the path within the optical waveguide than at the end of the path. Such loss of light due to absorption causes changes in color and/or brightness when the user's viewing angle changes.

Because the light bounces off the edges of the optical waveguide many times when propagating in the optical waveguide, even small amounts of absorption contribute significantly to the user's viewing quality. The small amount of absorption of each bounce compounds due to the many number of bounces that a light path encounters.

The anti-reflective coatings disclosed herein advantageously reduce/prevent any such absorption of the light path while still maintaining excellent transmission characteristics. Therefore, the anti-reflective coatings disclosed herein provide increased viewing quality for the user.

The embodiments disclosed herein include an anti-reflective coating comprising a plurality of first layers that each comprise a first material with a relatively high refractive index and a plurality of second layers that each comprise a second material with a relatively low refractive index. A total thickness of the first layers comprised of the first material is about 120 nm or less. Furthermore, the anti-reflective coating is configured to absorb about 0.25% or less of light for a single reflection of the average of the s- and p-polarizations of the light, at every wavelength between about 425 nm to about 495 nm, when the light is propagating under total internal reflection

The embodiments disclosed herein also include an anti-reflective waveguide comprising an optical waveguide configured to propagate a light path via total internal reflection and an anti-reflective coating on a surface of the optical waveguide. The anti-reflective coating comprises a plurality of first layers that each comprise a first material with a relatively high refractive index and a plurality of second layers that each comprise a second material with a relatively low refractive index. A total thickness of the first layers comprised of the first material is about 120 nm or less. Furthermore, the anti-reflective coating is configured to absorb about 0.25% or less of light for a single reflection of the average of the s- and p-polarizations of the light, at every wavelength between about 425 nm to about 495 nm, when the light is propagating under total internal reflection

The embodiments disclosed herein also include a method of propagating a light path within an anti-reflective waveguide that comprises an optical waveguide and an anti-reflective coating on a surface of the optical waveguide, the method comprising propagating the light path within the optical waveguide via total internal reflection with an absorption loss of about 0.25% or less for a single reflection of the average of the s- and p-polarizations of the light, at every wavelength between about 425 nm to about 495 nm.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a cross-sectional view of an article with an anti-reflective coating, according to embodiments of the present disclosure;

FIG. 2 is a cross-sectional view of an article with a detailed view of a multi-layer anti-reflective coating, according to embodiments of the present disclosure;

FIG. 3 is a graph of number of bounces of light vs. reflection of blue and violet wavelength light;

FIG. 4A is another cross-sectional view of an article with a detailed view of a multi-layer anti-reflective coating, according to embodiments of the present disclosure;

FIG. 4B is another cross-sectional view of an article with a detailed view of a multi-layer anti-reflective coating, according to embodiments of the present disclosure;

FIG. 4C is a cross-sectional view of an article with a detailed view of a comparative multi-layer anti-reflective coating; and

FIGS. 5A-8C are graphs of angle vs. percent reflectance for exemplary and comparative coatings.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

It is also important to note that the construction and arrangement of the elements of the disclosure, as shown in the exemplary embodiments, is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel and nonobvious teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures, and/or members, or connectors, or other elements of the system, may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present disclosure. Other substitutions, modifications, changes, and omissions may be made in the design, operating conditions, and arrangement of the desired and other exemplary embodiments without departing from the spirit of the present disclosure.

Reference will now be made in detail to the present preferred embodiments of the disclosure, examples of which are illustrated in the accompanying drawings.

Referring to FIG. 1, an article 1 according to one or more embodiments includes a substrate 10 and an anti-reflective coating 20 disposed on the substrate. Substrate 10 includes opposing surfaces 12, 14 such that anti-reflective coating 20 is disposed on surface 12. However, it is also contemplated that anti-reflective coating 20 is disposed on only surface 14 or on both surfaces 12 and 14. In the embodiment of FIG. 1, surface 14 may be disposed closer to a user's eye than surface 12. Additionally, anti-reflective coating 20 may be disposed on the entirety of or less than an entirety of substrate 10 along surface 12 and/or surface 14. Anti-reflective coating 20 may be in direct or indirect contact with substrate 10. For example, one or more materials may be disposed between anti-reflective coating 20 and substrate 10 such as, for example, an adhesive material. In the embodiment of FIG. 1, a diffractive optical element (not shown) is disposed on surface 14 at one or more locations.

Substrate 10 may be an optical waveguide, as discussed above, and may comprise glass or glass-ceramic such as, for example, silicate glass, an aluminosilicate glass, alkali aluminosilicate glass, alkaline aluminosilicate glass, borosilicate glass, boro-aluminosilicate glass, alkali aluminoborosilicate glass, alkaline aluminoborosilicate glass, soda-lime glass, fused quartz (fused silica), or other type of glass. Exemplary glass substrates include, but are not limited to, HPFS® fused silica sold by Corning Incorporated of Corning, N.Y. under glass codes 7980, 7979, and 8655, and EAGLE XG® boro-aluminosilicate glass also sold by Corning Incorporated of Corning, New York. Other glass substrates include, but are not limited to, Lotus™ NXT glass, Iris™ glass, WILLOW® glass, GORILLA® glass, VALOR® glass, or PYREX® glass sold by Corning Incorporated of Corning, N.Y. In other embodiments, substrate 10 comprises one or more transparent polymers such as, for example, thermoplastics including polystyrene (PS) (including styrene copolymers and blends), polycarbonate (PC) (including copolymers and blends), polyesters (including copolymers and blends, including polyethyleneterephthalate and polyethyleneterephthalate copolymers), polyolefins (PO) and cyclicpolyolefins (cyclic-PO), polyvinylchloride (PVC), acrylic polymers including polymethyl methacrylate (PMMA) (including copolymers and blends), thermoplastic urethanes (TPU), polyetherimide (PEI) and blends of these polymers with each other. Other exemplary polymers include epoxy, styrenic, phenolic, melamine, and silicone resins. The materials of anti-reflective coating 20 are discussed further below.

As shown in FIG. 1, light 30 of a virtual image propagates through substrate 10 along an axis A of substrate 10. As light 30 propagates, it bounces off the sides of substrates 10 at an angle θ. As discussed above, angle θ must be greater than the critical angle of substrate 10 (as calculated from Snell's Law) in order for light 30 to propagate via TIR. In embodiments disclosed herein, angle θ is greater than about 35 degrees, or greater than about 40 degrees, or from about 35 degrees to 80 degrees, or from about 40 degrees to about 80 degrees, or from about 35 degrees to about 70 degrees, or from about 40 degrees to about 70 degrees, or from about 50 degrees to about 60 degrees.

As also discussed above with regard to traditional coatings, some absorption loss may occur, thus diminishing the amount of light 30 that continues to propagate along axis A. For example, some light 35 may be absorbed by a traditional coating applied to substrate 10. The absorbed light 35 may be absorbed with each bounce that light 30 experiences as it propagates along axis A. Thus, with traditional coatings, the amount of light at position C is less than the amount of light at position B. The anti-reflective coatings of the present disclosure reduce the amount of absorbed light 35 compared to traditional coatings. In some embodiments of the present disclosure, and as discussed further below, the amount of absorbed light 35 is 0.0% so that the amount of light at position C is equal to the amount of light at position B.

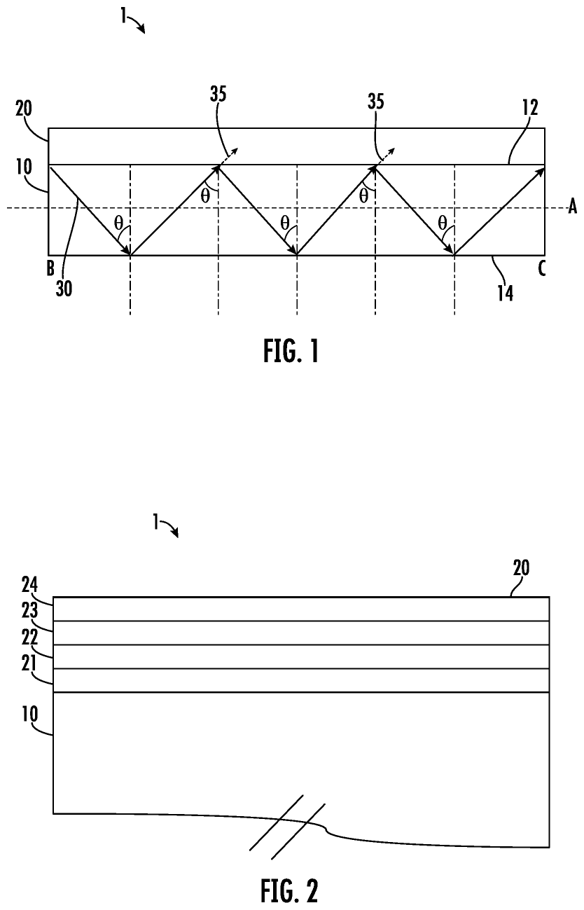

As shown in FIG. 2, anti-reflective coating 20 comprises multiple layers of materials. For example, anti-reflective coating 20 may comprise layers 21-24. Although the embodiment of FIG. 2 discloses four layers, it is also contemplated that more or less layers may be used. For example, anti-reflective coating 20 may comprise, one, two, three, five, six, seven, eight, nine, ten, eleven, twelve, or greater than twelve layers. In some embodiments, anti-reflective coating 20 comprises seven layers or less in order to obtain the desired thickness, as discussed further below.

The term “layer” may include a single layer or may include one or more sub-layers. Such sub-layers may be in direct contact with one another. The sub-layers may be formed from the same material or two or more different materials. In one or more alternative embodiments, the sub-layers may have intervening layers of different materials disposed therebetween. In one or more embodiments a layer may include one or more contiguous and uninterrupted layers and/or one or more discontinuous and interrupted layers (i.e., a layer having different materials formed adjacent to one another). Further each layer, for example each layer 21-24, may be in direct or indirect contact with its adjacent layers.

A layer or sub-layers may be formed by any known method in the art, including discrete deposition or continuous deposition processes. In one or more embodiments, the layers may be formed using only continuous deposition processes, or, alternatively, only discrete deposition processes.

As discussed further below, the number of layers, the thickness of each layer, and the material of each layer is optimized to provide a coating with minimal or zero absorption of light. Thus, the coatings disclosed herein have increased reflection under TIR. Additionally, the coatings disclosed herein increase the transmittance for real images.

The individual layers of anti-reflective coating 20 may comprise the same or different materials and may have the same or different refractive indexes as the other layers. For example, the layers may each comprise either a first material that has a relatively high refractive index or a second material that has a relatively low refractive index. Thus, for example, layers 21 and 23 may comprise the first material with the relatively high refractive index and layers 22 and 24 may comprise the second material with the relatively low refractive index. In this embodiment, it is also contemplated that the specific material of layer 21 is the same or different from the specific material of layer 23, as long as both layers comprise a material with a relatively high refractive index. Similarly, the specific material of layer 22 is the same or different from the specific material of layer 24, as long as both layers comprise a material with a relatively low refractive index.

The first material may have a refractive index higher than a refractive index of substrate 10. In some embodiments, the first material has a refractive index, at 850 nm, of about 1.6 or greater, or about 1.7 or about 1.8 or greater, or about 1.9 or greater, or about 2.0 or greater, or about 2.1 or greater, or about 2.2 or greater, or about 2.3 or greater, or about 2.4 or greater, or about 2.5 or greater, or about 2.6 or greater. Exemplary materials include, for example, Nb₂O₂, TiO₂, Ta₂O₅, HfO₂, Sc₂O₃, SiN, SiOₓN, and AlOₓN.

The second material may have a refractive index less than the refractive index of substrate 10. In some embodiments, the second material has a refractive index, at 850 nm, of about 1.6 or less, or about 1.5 or less, or about 1.4 or less, or about 1.3 or less, or about 1.2 or less. Exemplary materials include, for example, SiO₂, MgF₂, and AlF₃.

In some embodiments, substrate 10 comprises glass with a refractive index of about 1.5, or about 1.6, or about 1.7 at 850 nm, the first material has a refractive index greater than about 1.5, or about 1.6, or about 1.7 at 850 nm, and the second material has a refractive index less than about 1.5, or about 1.6, or about 1.7 at 850 nm.

A ratio of the refractive index of the first material to the refractive index of the second material is about 1.3 or greater, or about 1.4 or greater, or about 1.5 or greater, or about 1.6 or greater, or about 1.7 or greater. A higher ratio advantageously provides a higher transmittance with a reduced number of total layers, thus advantageously reducing the total thickness of the coating.

The layers of anti-reflective coating 20 may comprise alternating layers of the first material and of the second material. The layer of anti-reflective coating 20 that is directly adjacent to substrate 10 (for example, layer 21) may comprise the first material. Additionally, the layer of anti-reflective coating 20 that is furthest from substrate 10 (for example, layer 24) may comprise the second material.

A total thickness of anti-reflective coating 20 may be about 300 nm or less, or about 250 nm or less, or about 200 nm or less. Additionally or alternatively, the total thickness of anti-reflective coating 20 may be about 50 nm or more, or about 75 nm or more, or about 80 nm or more, or about 90 nm or more, or about 100 nm or more, or about 125 nm or more, or about 150 nm or more. In some embodiments, the coating has a total thickness in a range from about 75 nm to about 300 nm, or about 100 nm to about 250 nm, or about 200 nm to about 250 nm, or about 125 nm to about 225 nm.

The total thickness of anti-reflective coating 20 may be tailored and optimized depending on the materials selected for the layers. Furthermore, the total thickness must be sufficiently thick to properly propagate light 30 but should also be sufficiently thin to provide sufficient flexibility and to reduce manufacturing costs. In some embodiments, the total thickness of anti-reflective coating 20 is less than about 250 nm in order to provide the desired propagation of light while still maintaining flexibility and reduced manufacturing costs.

A total thickness of all layers that comprise the first material may be less than a total thickness of all layers that comprise the second material in order to reduce the amount of absorbed light 35. The first material, which has a relatively higher refractive index, starts absorbing light 30 before the second material, which has a relatively lower refractive index. Therefore, the total thickness of the first material layers may be reduced in order to provide the reduced absorption.

A ratio of the total thickness of the first material layers to a total thickness of the second material layers is in a range of about 0.2 to about 0.8, or about 0.3 to about 0.7, or about 0.4 to about 0.6, or about 0.5. The total thickness of the first material layers may be about 120 nm or less, or about 110 or less, or about 100 nm or less, or about 90 nm or less, or about 80 nm or less, or about 70 nm or less, or about 60 nm or less, or about 50 nm or less. In some embodiments, the total thickness of the first material layers is in a range from about 20 nm to about 70 nm, or about 30 nm to about 60 nm or about 40 nm to about 55 nm. For example, the total thickness of the first material layers is about 31 nm, or about 35 nm, or about 38 nm, or about 50 nm, or about 54 nm, or about 55 nm. The total thickness of the second material layers may be about 100 nm or greater, or about 120 nm or greater, or about 130 nm or greater, or about 140 nm or greater, or about 150 nm or greater, or about 160 nm or greater, or about 170 nm or greater. In some embodiments, the total thickness of the second material layers is in a range from about 100 nm to about 180 nm, or about 115 nm to about 165 nm, or about 130 nm to about 150 nm. For example, the total thickness of the second material layers is about 130 nm, or about 140 nm, or about 149 nm, or about 155 nm.

It is within the scope of the disclosure that one or more first material layers may have a different thickness from one or more other first material layers. Similarly, one or more second material layers may have a different thickness from one or more other second material layers. For example, with reference to FIG. 2, layers 21 and 23 may both comprise the first material, but layer 21 may have a different thickness from layer 23. Additionally or alternatively, layers 22 and 24 may both comprise the second material, but layer 22 may have a different thickness from layer 24. It is also contemplated that all the layers 21-24 have different thicknesses from each other.

For example, the layer of anti-reflective coating 20 that is directly adjacent to substrate 10 (layer 21 in FIG. 2) may have a thickness in a range of about 5 nm to about 60 nm, or about 10 nm to about 50 nm, or about 15 nm to about 45 nm, or about 20 nm to about 40 nm, or about 25 nm to about 35 nm. As discussed above, this layer of anti-reflective coating 20, which is directly adjacent to substrate 10, may have a reduced thickness in order to provide the reduced absorption. In some embodiments, this layer of anti-reflective coating 20 has a thickness of about 15 nm, or about 17 nm, or about 20 nm, or about 23 nm, or about 25 nm, or about 27 nm. This layer of anti-reflective coating 20 may comprise the first material and may have a thickness less than each of the remaining layers comprised of the first material.

The thickness of each first material layer may increase when moving away from substrate 10 (i.e., when moving upward in FIG. 2). Thus, in embodiments when layers 21 and 23 comprise the first material, layer 23 may have a greater thickness than layer 21. The thickness of each second material layer may also increase when moving away from substrate 10. Thus, in embodiments when layers 22 and 24 comprise the second material, layer 24 may have a greater thickness than layer 22.

As discussed above, the number of layers, the thickness of each layer, and the material of each layer of anti-reflective coating is optimized to provide reduced absorption of light 30 under TIR. Thus, anti-reflective coating 20 causes light at every wavelength within a red wavelength range (e.g., from 625 nm to 740 nm) to propagate within substrate 10 with an absorption loss of about 0.0% for a single reflection (i.e., bounce) of light. Additionally or alternatively, anti-reflective coating 20 causes light at every wavelength within a green wavelength range (e.g., from 500 nm to 565 nm) to propagate within substrate 10 with an absorption loss of about 0.0% for a single reflection (i.e., bounce) of light. Additionally or alternatively, anti-reflective coating 10 causes light at every wavelength within a blue and violet wavelength range (e.g., from 425 nm-495 nm) to propagate within substrate 10 with an absorption loss of about 6.0% or less, or about 5.0% or less, or about 4.0% or less, or about 3.0% or less, or about 2.0% or less, or about 1.5% or less, or about 1.0% or less, or about 0.75% or less, or about 0.60% or less, or about 0.50% or less, or about 0.40% or less, or about 0.25% or less, or about 0.20% or less, or about 0.10% or less, or about 0.05% or less, or about 0.04% or less, or about 0.03% or less, or about 0.02% or less, or about 0.01% or less, or about 0.0% for a single reflection (i.e., bounce) of light. It is noted that light within the blue/violet wavelength range has shorter wavelengths and therefore more energy than light within the red and green wavelength ranges. Thus, traditionally a greater amount of blue/violet wavelength light is absorbed by anti-reflective coatings than red or green wavelength light. However, the anti-reflective coatings of the present disclosure reduce the amount of absorption of not only red and green wavelength light, but also of blue/violet wavelength light.

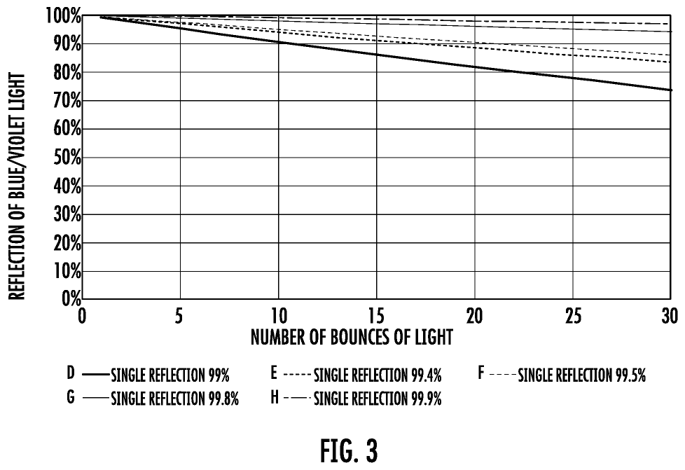

Because light 30 propagates many times within substrate 10, as discussed above, even a small amount of absorption compounds after many reflections (i.e., bounces) of the light. Thus, even if only a small amount of light is absorbed with each reflection of light 30 within substrate 10, the small amount of absorbed light quickly escalates after, for example, 20 reflections or 25 reflections within substrate 10. For example, as shown in FIG. 3, light path D has a reflection of 99% with each bounce of light (which corresponds to an absorption loss of 1% with each bounce of light), and light path H has a reflection of 99.9% with each bounce of light (which corresponds to an absorption loss of 0.1% with each bounce of light). It is noted that under TIR, light is either absorbed by the coating or reflected from the coating. Thus, under TIR, A+R=100%, where A is the amount of absorbed light and R is the amount of reflected light. It is again noted that it is desired to have a higher percent reflectance (which is equivalent to a lower percent absorption) in order to decrease the amount of light lost as the light propagates under TIR.

As also shown in FIG. 3, after 5 bounces of light, the difference in light reflected in the blue/violet wavelength range of light paths D and H is somewhat minimal (about 95% for light path D and about 99% for light path H). However, after 20 bounces, the difference in reflected light in the blue/violet wavelength range of light paths D and H is more substantial (about 81% for light path D and about 98% for light path H). After 30 bounces, the difference in reflected light in the blue/violet wavelength range of light paths D and H becomes even more substantial (about 75% for light path D and about 97% for light path H). Light paths D and H have only a small difference in absorption loss for each bounce of light. However, this small difference significantly increases when the light experiences many bounces under TIR. As discussed above, the anti-reflective coatings disclosed herein are optimized to provide minimal or zero absorption of light, even after many bounces under TIR.

The anti-reflective coatings disclosed herein also have about 95.0% or greater transmittance for every wavelength in the red, green, and blue/violet wavelengths, or about 96.0% or greater, or about 97.0% or greater, or about 98.0% or greater, or about 98.5% or greater, or about 99.0% or greater, or about 99.2% or greater, or about 99.5% or greater, or about 99.6% or greater, or about 99.7% or greater, or about 99.8% or greater, or about 99.9% or greater, or 100%. These disclosed transmittances are with reference to a direction orthogonal to a longitudinal length of the anti-reflective waveguide. As discussed above, a light path of a virtual image and of a real image are coupled out of or transmit through an optical waveguide and overlap in the user's eye to create the augmented or virtual reality for the user. Thus, the anti-reflective coatings of the present disclosure advantageously provide a high rate of transmittance, which increases the quality of the image produced for the user.

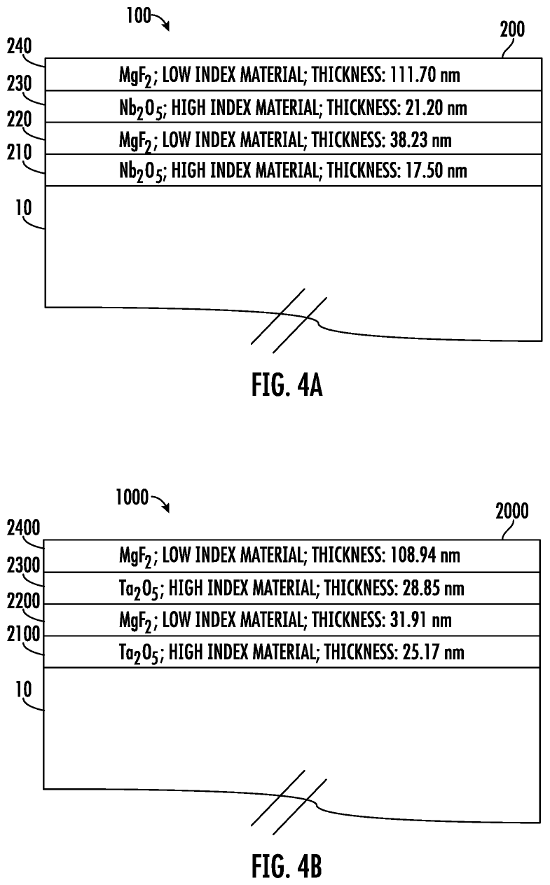

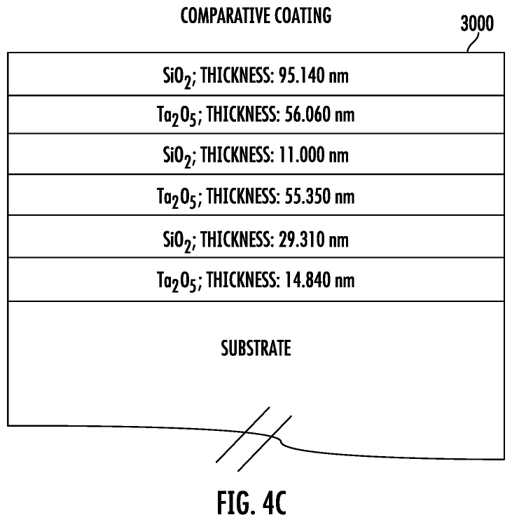

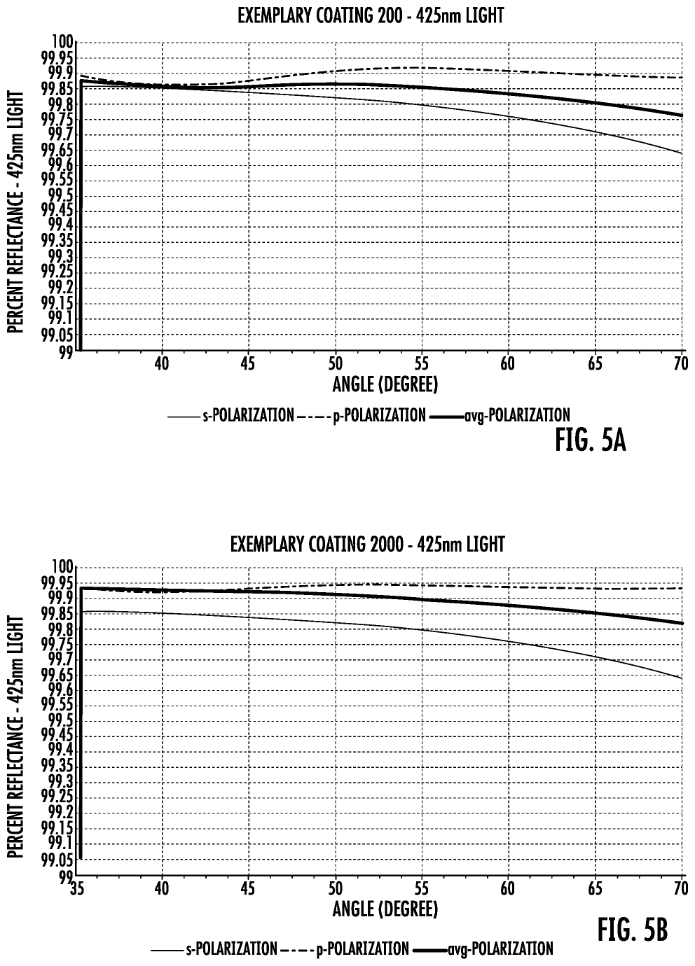

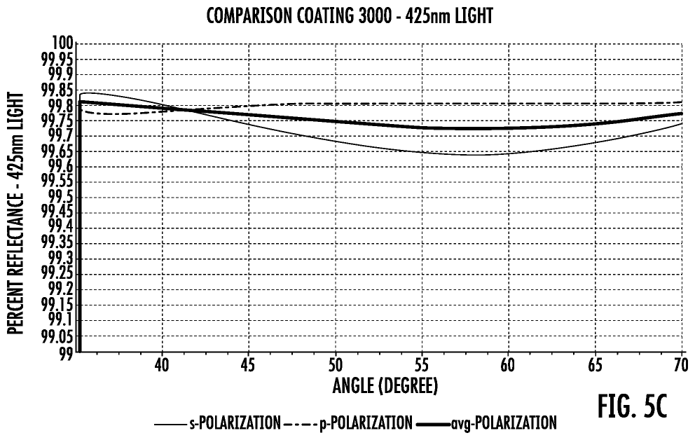

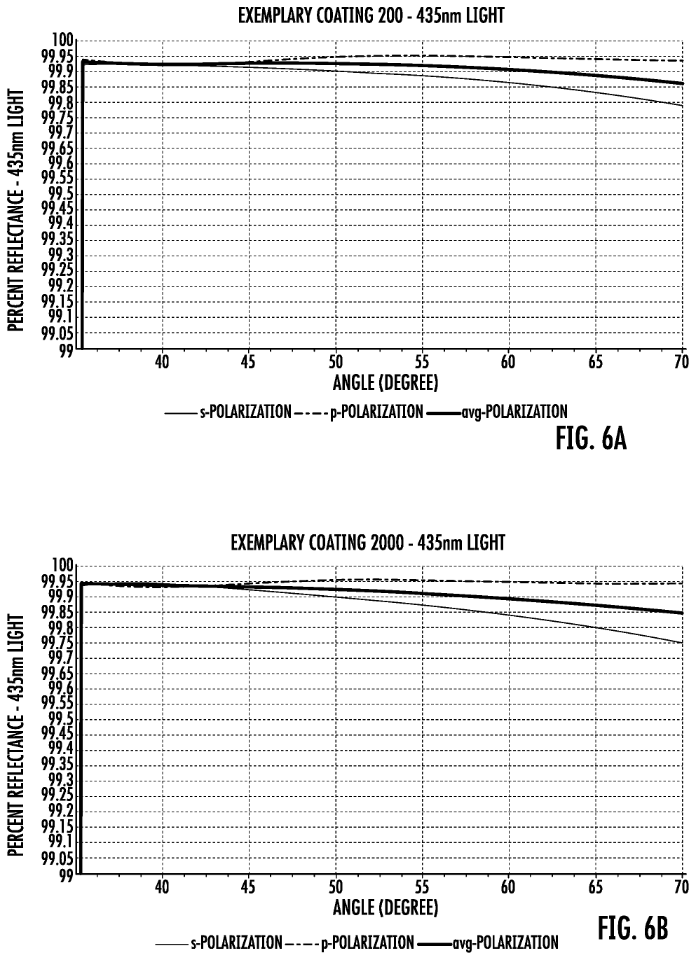

FIG. 4A is an exemplary embodiment of article 100 in which layers 210 and 230 of anti-reflective coating 200 both comprise Nb₂O₂ (first material layers), and layers 220 and 240 of anti-reflective coating 200 both comprise MgF₂ (second material layers). In this embodiment, layer 210 is directly adjacent to substrate 10 and has a thickness less than a thickness of layer 230. More specifically, layer 210 has a thickness of 17.50 nm and layer 230 has a thickness of 21.20 nm. Additionally, layer 220 has a thickness of 38.23 nm, which is less than the 111.70 nm thickness of layer 240. The total thickness of the first material layers (layers 210+230) is 38.70 nm, and the total thickness of the second material layers (layers 220+240) is 149.93 nm. The total thickness of anti-reflective coating 200 in this embodiment is 188.63 nm.

FIG. 4B is a second exemplary embodiment of article 1000 in which layers 2100 and 2300 of anti-reflective coating 2000 both comprise Ta₂O₅ (first material layers), and layers 2200 and 2400 of anti-reflective coating 2000 both comprise MgF₂ (second material layers). In this embodiment, layer 2100 is directly adjacent to substrate 10 and has a thickness less than a thickness of layer 2300. More specifically, layer 2100 has a thickness of 25.17 nm and layer 2300 has a thickness of 28.85 nm. Additionally, layer 2200 has a thickness of 31.91 nm, which is less than the 108.94 nm thickness of layer 2400. The total thickness of the first material layers (layers 2100+2300) is 54.02 nm, and the total thickness of the second material layers (layers 2200+2400) is 140.85 nm. The total thickness of anti-reflective coating 2000 in this embodiment is 194.87 nm.

FIG. 4C provides a comparative example of an article with an anti-reflective coating 3000 having six layers of material. As shown in FIG. 4C, comparative coating 3000 has more layers and a greater total thickness than the exemplary coatings of FIGS. 4A and 4B. Specifically, comparative coating 3000 has a total thickness of 261.70 nm, which is greater than the 188.63 nm thickness of exemplary coating 200 and greater than the 194.87 nm thickness of exemplary coating 2000. Furthermore, a total thickness of the high refractive index material (Ta₂O₅) of comparative coating 3000 of FIG. 4C is 126.25 nm, which is much greater than the 38.70 nm thickness for coating 200 and the 54.02 nm thickness of coating 2000. Because the comparative example has a greater amount of material with a high refractive index, it has a higher rate of absorption (and, thus a lower rate of reflection), as shown below.

FIGS. 5A-5C provide a comparison of the percent reflectance of exemplary coatings 200 and 2000 with comparison coating 3000 for a 425 nm light path. It is noted that in FIGS. 5A-5C, the light propagates via TIR at an angle from about 40 degrees to about 70 degrees, in order to be above the critical angle of the optical waveguide. As discussed above, the light path must propagate within the optical waveguide at an angle greater than the critical angle in order propagate under TIR.

It is also noted that polarized light includes two orthogonal linear polarization states: s polarization (which is perpendicular to the plane of incidence) and p polarization (which is parallel to the plane of incidence). FIGS. 5A-5C depict the percent reflectance for the s-polarized light, the p-polarized light, and the average s-polarized and p-polarized light. The average s- and p-polarization plots are discussed below for comparison purposes. An average s- and p-polarization plot with a higher percent reflectance reduces color shifting and non-uniformity of brightness in an image viewed by the user. Such also reduces striations or streaks in the image, thus increasing the viewing quality for the user.

The average s- and p-polarization plots have a higher percent reflectance when using exemplary coating 200 (FIG. 5A) and exemplary coating 2000 (FIG. 5B) compared when using comparison coating 3000 (FIG. 5C). For example, when using exemplary coating 200 (FIG. 5A) or exemplary coating 2000 (FIG. 5B), the average s- and p-polarization plot has above 99.75% reflectance over the angle range of 40 degrees to 70 degrees. Conversely, when using comparison coating 3000 (FIG. 5C), the average s- and p-polarization plot falls below 99.75% reflectance over this angle range. Thus, comparison coating 3000 has less percent reflectance (and, thus, a higher percent absorption) when using 425 nm light.

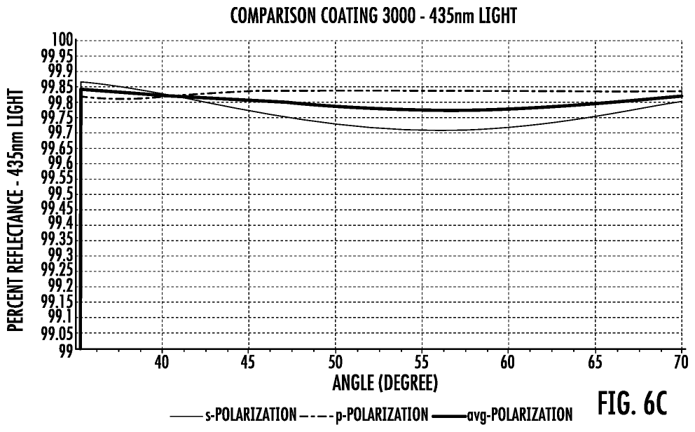

FIGS. 6A-6C provide a comparison of the percent reflectance of exemplary coatings 200 and 2000 with comparison coating 3000 for a 435 nm light path. Similar to FIGS. 5A-5C, the average s- and p-polarization plots each have a higher percent reflectance when using exemplary coating 200 (FIG. 6A) and exemplary coating 2000 (FIG. 6B) compared when using comparison coating 3000 (FIG. 6C). For example, when using exemplary coating 200 (FIG. 6A) or exemplary coating 2000 (FIG. 6B), the average s- and p-polarization plot has 99.85% reflectance or above over the angle range of 40 degrees to 70 degrees. Conversely, when using comparison coating 3000 (FIG. 6C), the average s- and p-polarization plot falls below 99.85% reflectance over this angle range. Thus, comparison coating 3000 has less percent reflectance (and, thus, a higher percent absorption) when using 435 nm light.

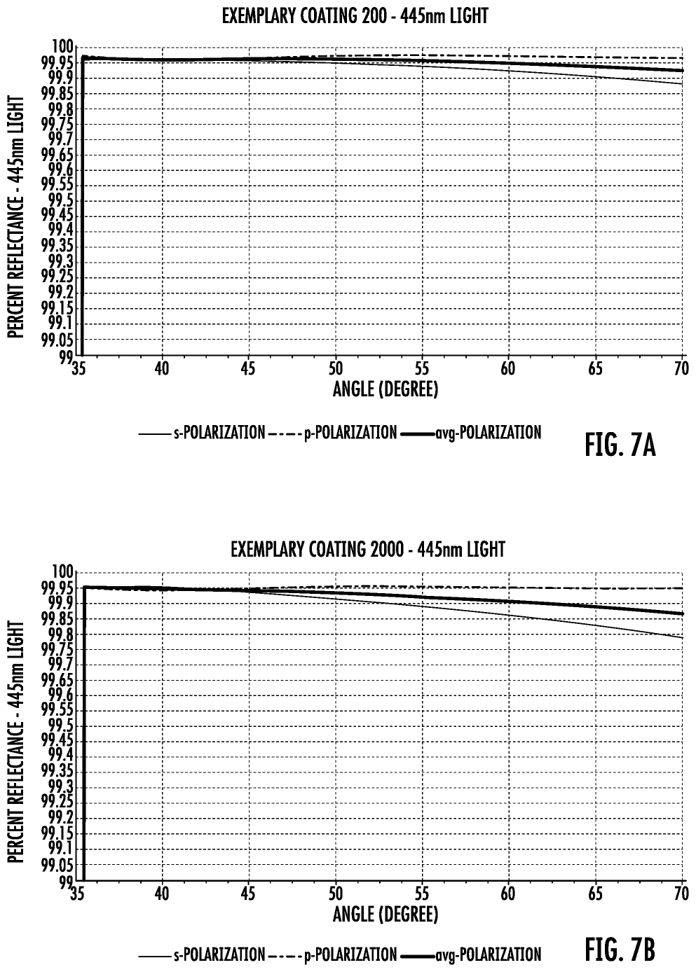

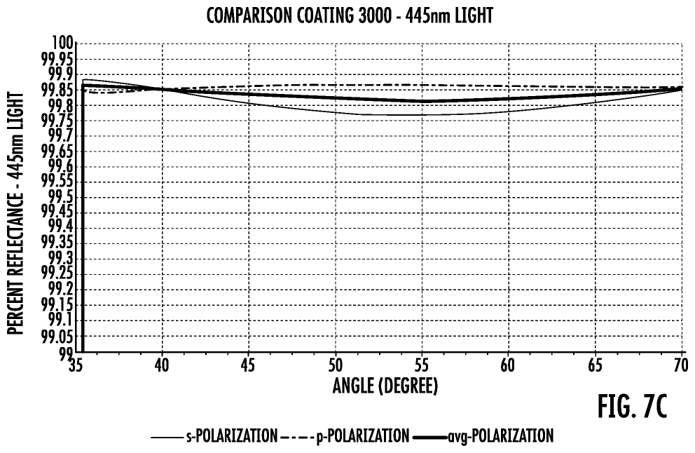

FIGS. 7A-7C provide a comparison of the percent reflectance of exemplary coatings 200 and 2000 with comparison coating 3000 for a 445 nm light path. Similar to FIGS. 5A-5C, the average s- and p-polarization plots each have a higher percent reflectance when using exemplary coating 200 (FIG. 7A) and exemplary coating 2000 (FIG. 7B) compared when using comparison coating 3000 (FIG. 7C). For example, when using exemplary coating 200 (FIG. 7A) or exemplary coating 2000 (FIG. 7B), the average s- and p-polarization plot has above 99.85% reflectance over the angle range of 40 degrees to 70 degrees. Conversely, when using comparison coating 3000 (FIG. 7C), the average s- and p-polarization plot falls below 99.85% reflectance over this angle range. Thus, comparison coating 3000 has less percent reflectance (and, thus, a higher percent absorption) when using 445 nm light.

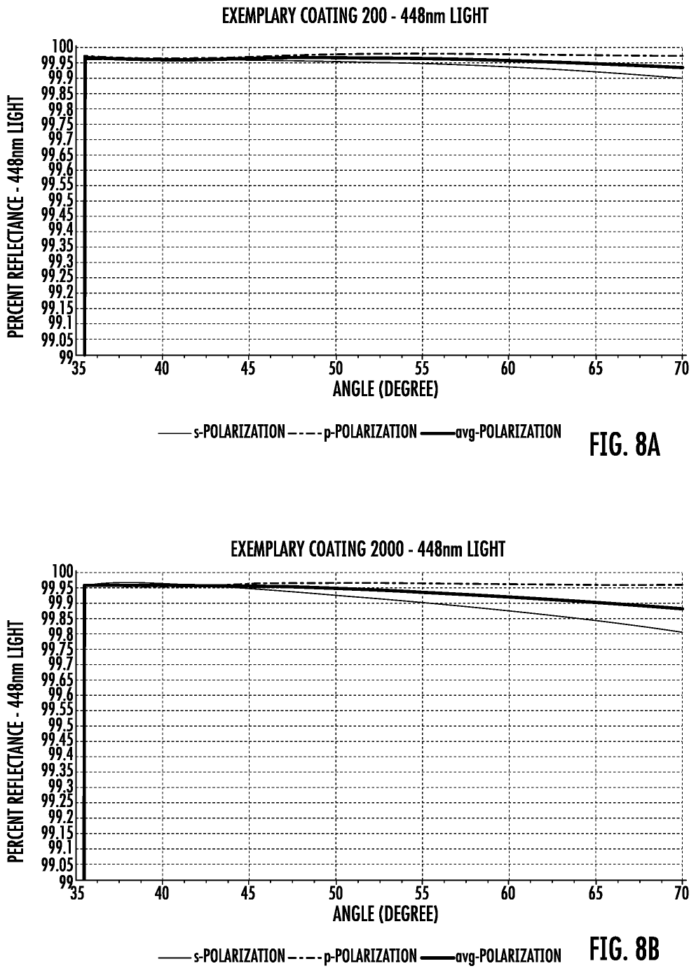

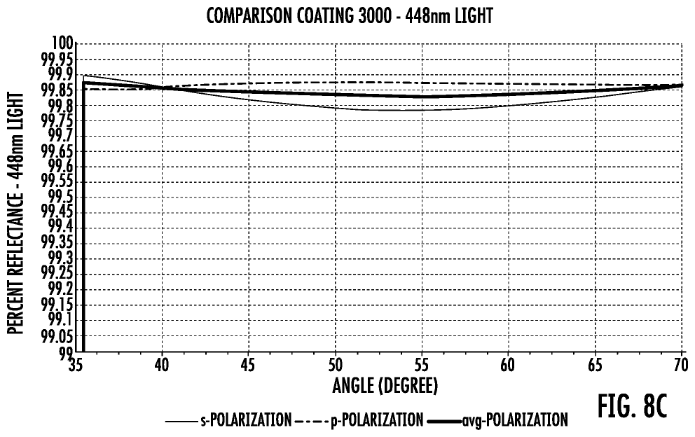

FIGS. 8A-8C provide a comparison of the percent reflectance of exemplary coatings 200 and 2000 with comparison coating 3000 for a 448 nm light path. Similar to FIGS. 5A-5C, the average s- and p-polarization plots each have a higher percent reflectance when using exemplary coating 200 (FIG. 8A) and exemplary coating 2000 (FIG. 8B) compared when using comparison coating 3000 (FIG. 8C). For example, when using exemplary coating 200 (FIG. 8A) or exemplary coating 2000 (FIG. 8B), the average s- and p-polarization plot has above 99.85% reflectance over the angle range of 40 degrees to 70 degrees. Conversely, when using comparison coating 3000 (FIG. 8C), the average s- and p-polarization plot falls below 99.85% reflectance over this angle range. Thus, comparison coating 3000 has less percent reflectance (and, thus, a higher percent absorption) when using 448 nm light.

The exemplary coatings disclosed herein optimize the number of layers of material, the thickness of each layer, and the specific material of each layer in order to reduce reflectivity, reduce glare, increase transmittance, and reduce color shifting when an image is viewed from a different angle.

The present disclosure also includes a method of propagating a light path within an anti-reflective waveguide such that the waveguide comprises an optical waveguide and an anti-reflective coating of the present disclosure. Thus, the method comprises propagating the light path via TIR with the reduced absorption loss (increased reflection) and increased transmittance, as discussed above.

The description of the embodiments of the present disclosure is not intended to be exhaustive or to limit the disclosure. While specific embodiments and examples of the disclosure are described herein for illustrative purposes, various equivalent modifications are possible within the scope of the disclosure, as those skilled in the relevant art will recognize. Such modifications may include, but are not limited to, changes in the dimensions and/or the materials shown in the disclosed embodiments.

What is claimed is:

1. An anti-reflective coating comprising:
a plurality of first layers that each comprise a first material with a relatively high refractive index; and
a plurality of second layers that each comprise a second material with a relatively low refractive index,
wherein:
a total thickness of the first layers comprised of the first material is about 120 nm or less, and
the anti-reflective coating is configured to absorb about 0.25% or less of light for a single reflection of the average of the s- and p-polarizations of the light, at every wavelength between about 425 nm to about 495 nm, when the light is propagating under total internal reflection.

2. The anti-reflective coating of claim 1, wherein the anti-reflective coating is configured to absorb about 0.20% or less of light for a single reflection of the average of the s- and p-polarizations of the light, at every wavelength between about 425 nm to about 495 nm, when the light is propagating under total internal reflection.

3. The anti-reflective coating of claim 1, wherein the anti-reflective coating is configured to absorb about 0.15% or less of light for a single reflection of the average of the s- and p-polarizations of the light, at every wavelength between about 425 nm to about 495 nm, when the light is propagating under total internal reflection.

4. The anti-reflective coating of claim 1, wherein the anti-reflective coating comprises alternating layers of the first material and of the second material.

5. The anti-reflective coating of claim 1, wherein the first material has a refractive index of about 1.8 or greater at 850 nm.

6. The anti-reflective coating of claim 5, wherein the first material has a refractive index of about 1.9 or greater at 850 nm.

7. The anti-reflective coating of claim 1, wherein the first material comprises at least one of Nb₂O₂, TiO₂, Ta₂O₅, HfO₂, Sc₂O₃, SiN, SiOxN, and AlOxN.

8. The anti-reflective coating of claim 1, wherein the total thickness of the first layers is about 100 nm or less.

9. The anti-reflective coating of claim 1, wherein a first layer of the plurality of first layers has a thickness in a range of about 10 nm to about 50 nm.

10. The anti-reflective coating of claim 1, wherein the second material has a refractive index of about 1.5 or less at 850 nm.

11. The anti-reflective coating of claim 1, wherein the second material comprises at least one of SiO₂, MgF₂, and AlF₃.

12. The anti-reflective coating of claim 1, wherein a total thickness of the second layers is about 150 nm or less.

13. The anti-reflective coating of claim 1, wherein the total thickness of the first layers is less than a total thickness of the second layers.

14. The anti-reflective coating of claim 1, wherein a ratio of the total thickness of the first layers to a total thickness of the second layers is in a range of about 0.3 to about 0.7.

15. The anti-reflective coating of claim 1, wherein the total thickness of the first layers and a total thickness of the second layers combined is about 250 nm or less.

16. The anti-reflective coating of claim 1, wherein a percent transmission of the anti-reflective coating is about 98.0% or greater.

17. The anti-reflective coating of claim 1, wherein the light path propagates under total internal reflection with a bend angle in a range of about 40 degrees to about 70 degrees.

18. An anti-reflective waveguide comprising:
an optical waveguide configured to propagate a light path via total internal reflection; and
an anti-reflective coating on a surface of the optical waveguide, the anti-reflective coating comprising a plurality of first layers that each comprise a first material with a relatively high refractive index and a plurality of second layers that each comprise a second material with a relatively low refractive index,
wherein:
a total thickness of the first layers comprised of the first material is about 120 nm or less, and
the anti-reflective coating is configured to absorb about 0.25% or less of light for a single reflection of the average of the s- and p-polarizations of the light, at every wavelength between about 425 nm to about 495 nm, when the light is propagating under total internal reflection.

19. The anti-reflective waveguide of claim 18, wherein the first material has a refractive index greater than a refractive index of the optical waveguide and the second material has a refractive index less than the refractive index of the optical waveguide.

20. The anti-reflective waveguide of claim 18, wherein a first layer of the plurality of first layers, which is directly adjacent to the optical waveguide, has a thickness in a range of about 5 nm to about 60 nm.
